(19) United States
(12) Patent Application Publication
(10) Pub. No.: US 2014/0141823 A1
(43) Pub. Date: May 22, 2014

(54) COMMUNICATION DEVICE, COMUNICATION METHOD AND COMPUTER PROGRAM PRODUCT

(71) Applicant: KABUSHIKI KAISHA TOSHIBA, Tokyo (JP)

(72) Inventors: Tatsuo Kozakaya, Kanagawa (JP); Tomoki Watanabe, Kanagawa (JP); Ryuzo Okada, Kanagawa (JP); Yoshihiro Oba, Kanagawa (JP); Mitsuru Kanda, Tokyo (JP); Yasuyuki Tanaka, Kanagawa (JP); Takaomi Murakami, Kanagawa (JP); Seijiro Yoneyama, Kanagawa (JP)

(73) Assignee: KABUSHIKI KAISHA TOSHIBA, Tokyo (JP)

(21) Appl. No.: 14/078,911

(22) Filed: Nov. 13, 2013

(30) Foreign Application Priority Data
Nov. 20, 2012 (JP) 2012-254602

(51) Int. Cl. H04W 40/20; G06T 7/00

(52) U.S. Cl. CPC H04W 40/20; G06T 7/004
USPC 455/500

(57) ABSTRACT

According to an embodiment, a communication device includes an analyzer, a switching unit and a communication unit. The analyzer is configured to analyze an image taken at a periphery of the communication device. The switching unit is configured to switch a communication counterpart from a first communication device to a second communication device based on an analysis result of the image. The communication unit is configured to communicate with the second communication device after switching.

### CROSS-REFERENCE TO RELATED APPLICATION(S)

This application is based upon and claims the benefit of priority from Japanese Patent Application No. 2012-254602, filed on Nov. 20, 2012; the entire contents of which are incorporated herein by reference.

### FIELD

Embodiments described herein relate generally to a communication device, a communication method and a computer program product.

### BACKGROUND

There is a technique of determining, in the case of performing wireless communication with a wireless communication device existing in the periphery, presence or absence of a communication obstacle by detecting the surrounding environment, in order to transmit information to be transmitted to a larger number of wireless communication devices.

According to such a technique, in the case there is no communication obstacle in the periphery, information to be transmitted is transmitted to all the wireless communication devices existing in the communication range, whereas in the case there is a communication obstacle in the periphery, information to be transmitted is transmitted to all the wireless communication devices existing in the communication range with information requesting relaying added thereto, and the wireless communication devices further relay and transmit the information to be transmitted.

### BRIEF DESCRIPTION OF THE DRAWINGS

FIG. 1 is a configuration diagram illustrating an example of a wireless communication device of a first embodiment;

FIG. 2 is an explanatory diagram of an example of a communication counterpart switching method of the first embodiment;

FIG. 3 is an explanatory diagram of an example of the communication counterpart switching method of the first embodiment;

FIG. 4 is a flow chart showing an example of the communication counterpart switching method;

FIG. 5 is a configuration diagram illustrating an example of a wireless communication device of a second embodiment;

FIG. 6 is an explanatory diagram of an example of a communication counterpart switching method of the second embodiment;

FIG. 7 is a flow chart showing an example switching method of the second embodiment;

FIG. 8 is a configuration diagram illustrating an example of a wireless communication device of a third embodiment;

FIG. 9 is an explanatory diagram of an example of correlation information of the third embodiment;

FIG. 10 is a flow chart showing an example switching method of the third embodiment; and

FIG. 11 is a diagram illustrating an example hardware configuration of a wireless communication device of each embodiment and each example modification.

### DETAILED DESCRIPTION

According to an embodiment, a communication device includes an analyzer, a switching unit and a communication unit. The analyzer is configured to analyze an image taken at a periphery of the communication device. The switching unit is configured to switch a communication counterpart from a first communication device to a second communication device based on an analysis result of the image. The communication unit is configured to communicate with the second communication device after switching.

Hereinafter, various embodiments will be described in detail with reference to appended drawings.

### First Embodiment

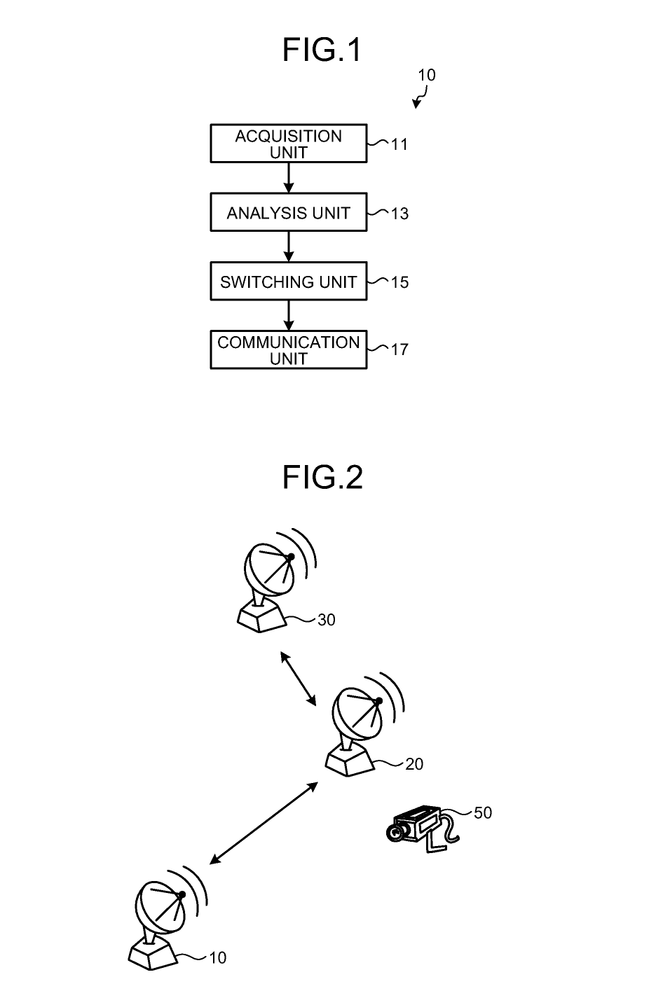

FIG. 1 is a configuration diagram illustrating an example of a wireless communication device 10 of a first embodiment. As illustrated in FIG. 1, the wireless communication device 10 includes an acquisition unit 11, an analysis unit 13, a switching unit 15, and a communication unit 17.

The acquisition unit 11, the analysis unit 13, the switching unit 15, and the communication unit 17 may be implemented by causing a processing device such as a CPU (Central Processing Unit) or the like to execute programs, that is, by software, or may be realized by hardware such as an IC (Integrated Circuit) or the like, or may be implemented by both software and hardware, for example.

The acquisition unit 11 acquires an image obtained by photographing the periphery of the wireless communication device 10. Specifically, an imaging device such as a digital camera (not illustrated in FIG. 1) sequentially photographs the periphery of the wireless communication device 10, and the acquisition unit 11 sequentially acquires images obtained by photographing the periphery of the wireless communication device 10 from the imaging device.

The periphery of the wireless communication device 10 is the space that affects the communication quality of the wireless communication device 10 as well as its surrounding space, for example, but this is not restrictive. For example, the space that affects the communication quality and its surrounding space may be defined in advance by measuring, in a test environment or estimating from a theoretical value or a prediction value, how many people or cars passing through which space near the wireless communication device 10 would affect the communication quality to what degree in the case of the wireless communication device 10 wirelessly communicating with another wireless communication device (not illustrated in FIG. 1).

The number of imaging devices may be one or more. For example, there may be a plurality of imaging devices, and the acquisition unit 11 may acquire images captured from a plurality of directions (capturing positions), so as to widen the analysis range of the analysis unit 13 described later. The imaging device may be provided to the wireless communication device 10, or it may be a separate device from the wireless communication device 10, such as an existing security camera.

The analysis unit 13 analyzes the communication quality of the wireless communication device 10. The communication quality of the wireless communication device 10 may be reduced (deteriorated) not only by a negative influence on wireless communication itself, such as radio wave interference, but also by a negative influence caused by the presence of an object which may become an obstacle for the wireless communication between the wireless communication device 10 and another wireless communication device. Moreover, if an object which may become an obstacle is a known stationary object such as a wall, it may be dealt with in advance (the negative influence on the communication quality may be eliminated), but if a moving object such as a person or a car temporarily becomes an obstacle by moving, it cannot be dealt with in advance.

Accordingly, in the first embodiment, the analysis unit 13 analyzes an image acquired by the acquisition unit 11 and detects presence or absence of an object which may become an obstacle for the wireless communication between the wireless communication device 10 and another wireless communication device to thereby analyze and evaluate the communication quality of the wireless communication device 10.

Specifically, the analysis unit 13 sequentially analyzes images acquired by the acquisition unit 11, and in the case an object which may become an obstacle for wireless communication is detected, the analysis unit 13 analyzes and evaluates the communication quality of the wireless communication device 10 based on the detected object. For example, if the degree of influence of the object on the communication quality has been measured in a test environment or has been estimated from a theoretical value or a prediction value, as described above, a table in which information, such as the type of an object, the number of objects, the position and the like is associated with the degree of influence on the communication quality is stored in a storage unit (not illustrated in FIG. 1), and the analysis unit 13 refers to this table, acquires the degree of influence on the communication quality based on the type, the number, the position and the like of the detected object(s), and evaluates the communication quality of the wireless communication device 10.

The analysis unit 13 may detect an object which may become an obstacle for wireless communication using a technique of detecting a specific object, such as a person, a face, a car or the like, from an image. As the technique for detecting a specific object, there is T. Watanabe, S. Ito, and K. Yokoi, “Co-occurrence histograms of oriented gradients for pedestrian detection,” in PSIVT, 2009, pp. 37-47, for example, which is a human detection technique that uses co-occurrence histograms of oriented gradients.

The switching unit 15 switches the communication counterpart from a first wireless communication device to a second wireless communication device based on an analysis result of the analysis unit 13. Specifically, in the case the analysis result of the analysis unit 13 indicates that the quality of communication with the first wireless communication device with which communication is currently being performed decreases, the switching unit 15 cuts the connection for wireless communication with the first wireless communication device, and establishes a connection for wireless communication with the second wireless communication device which is the switching destination.

The second wireless communication device to be the switching destination is determined according to the positional relationship to the object which may become an obstacle detected by the analysis unit 13. Specifically, the switching unit 15 determines, as the second wireless communication device to be the switching destination, another wireless communication device with respect to which the object which may become an obstacle detected by the analysis unit 13 is not present at a position that would block the wireless communication with the wireless communication device 10. Also, the second wireless communication device may be determined further taking into consideration the intensity of radio wave to/from the wireless communication device 10. For example, the switching unit 15 determines, as the second wireless communication device to be the switching destination, another wireless communication device with respect to which the object which may become an obstacle detected by the analysis unit 13 is not present at a position that would block the wireless communication with the wireless communication device 10, whose distance to the object is a predetermined distance or more, and for which the intensity of radio wave to/from the wireless communication device 10 is equal to or higher than a predetermined value. Here, the order of priority between the distance and the intensity of radio wave is dependent on the application, and for example, in the case a priority is placed on the stability of the communication quality, a parameter may be given from outside so as to prioritize increasing the distance from the cause of quality reduction.

The positional relationship to other wireless communication device located around the wireless communication device 10 may be specified in advance at the time of installation based on map information such as a map, an information map, a station map or the like, or may be autonomously obtained according to the intensity of radio wave between wireless communication devices or positioning information, or if outdoors, positioning by a GPS (Global Positioning System) may be used. Moreover, by tracking a specific object and establishing correspondence between objects across cameras using an image recognition technology, the positional relationship between the wireless communication devices may be grasped based on the progress information of the order of passing by the cameras. Incidentally, in this case, the positional relationship between the cameras and the wireless communication devices has to be known.

In the case the analysis unit 13 no longer detects the object which may become an obstacle for wireless communication, or the intensity of radio wave has returned to before, or a predetermined time has passed, the switching unit 15 may restore the communication counterpart. That is, the connection for wireless communication with the second wireless communication device which is the switching destination may be cut off, and connection for wireless communication with the first wireless communication device which is the restored device may be established.

Additionally, the switching unit 15 may perform switching not only for the wireless communication device 10, but also for other wireless communication devices.

The communication unit 17 performs wireless communication with another wireless communication device which is the communication target (another wireless communication device with respect to which connection for wireless communication is established).

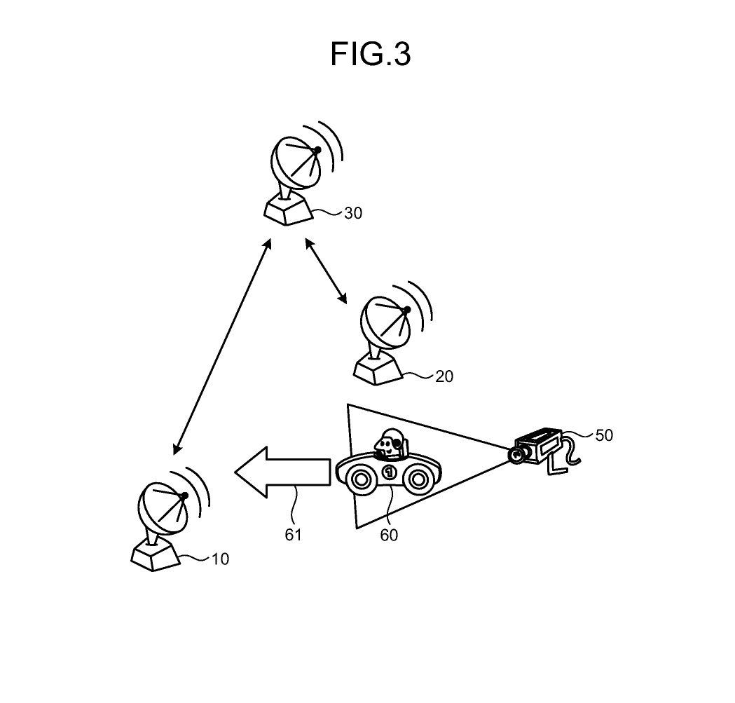

FIGS. 2 and 3 are explanatory diagrams of examples of a communication counterpart switching method of the first embodiment, and FIG. 2 illustrates a state where an object which may become an obstacle for wireless communication is not detected (a normal state), and FIG. 3 illustrates a state where an object which may become an obstacle for wireless communication is detected.

In the example illustrated in FIG. 2, since an imaging unit 50 is not capturing any object, the analysis unit 13 does not detect an object which may become an obstacle for wireless communication with the wireless communication device 10. In this case, connection for wireless communication is established for the wireless communication device 10 and a wireless communication device 20 which is a communication target with the highest wireless efficiency, for example, with the distance between the devices being the shortest, or with the intensity of radio wave between the devices being the highest, and the communication unit 17 performs wireless communication with the wireless communication device 20.

On the other hand, in the example illustrated in FIG. 3, it is assumed that the imaging unit 50 captures a vehicle 60 moving in the direction of an arrow 61, and that the analysis unit 13 detects the vehicle 60 from an image captured by the imaging unit 50 and acquired by the acquisition unit 11, and evaluates that the vehicle 60 reduces the communication quality of the wireless communication between the wireless communication device 10 and the wireless communication device 20. In this case, the switching unit 15 determines a wireless communication device 30 as the second wireless communication device, which is the switching destination, by using the method described above, cuts the connection for wireless communication with the wireless communication device 20, and establishes a connection for wireless communication with the wireless communication device 30, and the communication unit 17 performs wireless communication with the wireless communication device 30.

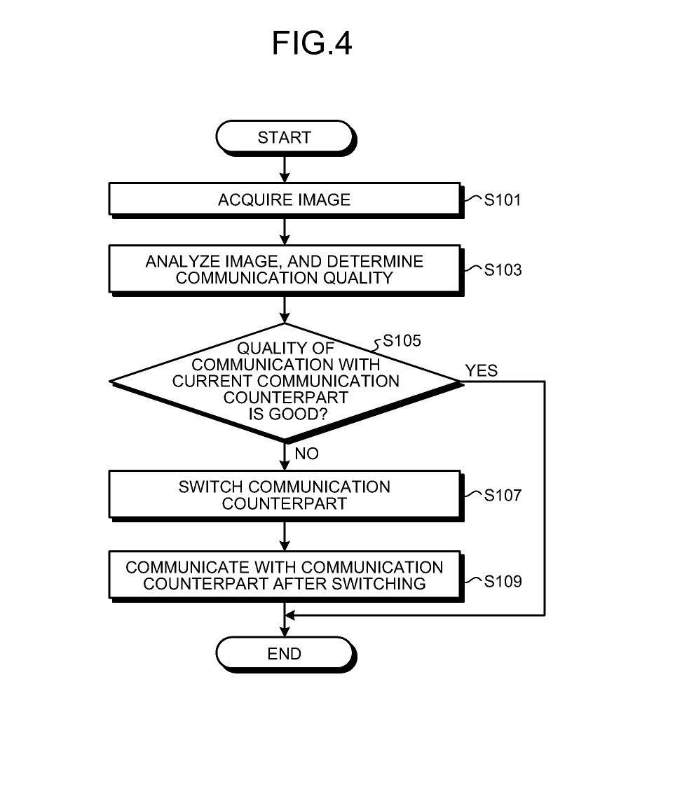

FIG. 4 is a flow chart showing an example of the communication counterpart switching method performed by the wireless communication device 10 of the first embodiment.

First, the acquisition unit 11 acquires an image obtained by photographing the periphery of the wireless communication device 10 (step S101).

Then, the analysis unit 13 analyzes the image acquired by the acquisition unit 11, detects presence or absence of an object which may become an obstacle for wireless communication between the wireless communication device 10 and another wireless communication device, to thereby determine the communication quality of the wireless communication device 10 (step S103).

Next, the switching unit 15 checks, based on the analysis result of the analysis unit 13, whether the quality of communication with the other wireless communication device with which communication is currently being performed is good or not (step S105). In the case the quality of communication with the other wireless communication device with which communication is currently being performed is good (Yes in step S105), the process is ended.

On the other hand, in the case the quality of communication with the other wireless communication device with which communication is currently being performed is not good (No in step S105), the switching unit 15 switches the communication counterpart (step S107).

Then, the communication unit 17 performs wireless communication with another wireless communication device which is the switching destination (step S109).

As described above, according to the first embodiment, when an object which may cause reduction in communication quality is detected from an image obtained by photographing the periphery of the wireless communication device, the communication counterpart is switched, and the influence of reduction in communication quality may be suppressed.

### Second Embodiment

In a second embodiment, an example of predicting reduction in communication quality will be described. In the following, the difference to the first embodiment will be mainly described, and structural elements having the same functions as in the first embodiment will be denoted with the same names and reference signs as in the first embodiment, and their description will be omitted.

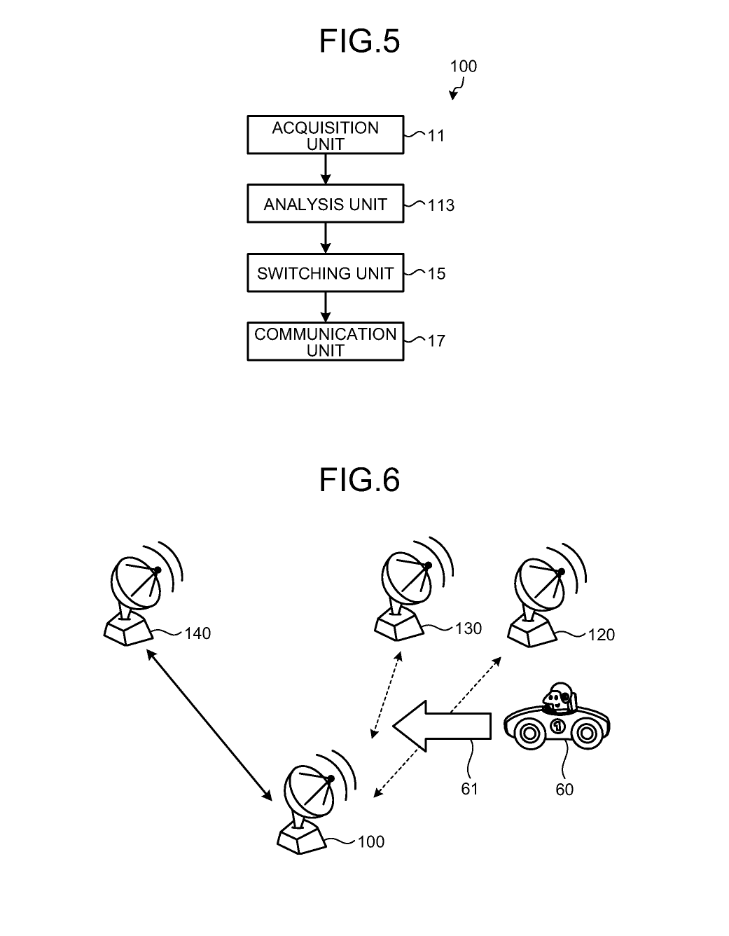

FIG. 5 is a configuration diagram illustrating an example of a wireless communication device 100 of the second embodiment. As illustrated in FIG. 5, the wireless communication device 100 of the second embodiment is different from the first embodiment with respect to an analysis unit 113.

The analysis unit 113 analyzes an image acquired by the acquisition unit 11 and detects presence or absence of an object which may become an obstacle for wireless communication between the wireless communication device 100 and another wireless communication device to thereby analyze and evaluate the communication quality of the wireless communication device 100.

Specifically, the analysis unit 113 sequentially analyzes images sequentially acquired by the acquisition unit 11, and obtains the number of objects detected, the positions, the movement speed, and the movement directions. Then, the analysis unit 113 refers to the table stored in a storage unit (not illustrated in FIG. 5), acquires the degree of influence that may be exerted on the communication quality in the future if the detected object group moves at the detected movement speed and in the detected movement direction, and predicts the communication quality of the wireless communication device 100.

Alternatively, prediction of reduction in the communication quality may be performed using not object detection, but a background differencing technique of calculating a difference image between a background captured in a normal situation and an acquired image at the current time point or an optical flow technique. In this case, if there is a movement in the screen, that is, if there is a difference to the background, the presence or absence of an object which may become an obstacle may be detected, and the speed of change may be obtained by optical flow. When the speed of image change is obtained, the degree of influence that may be exerted on the communication quality in the future if the detected object moves at the detected movement speed and in the detected movement direction is acquired in the same manner as in the object detection, and the communication quality of the wireless communication device 100 is evaluated.

FIG. 6 is an explanatory diagram of an example of a communication counterpart switching method of the second embodiment. In the example illustrated in FIG. 6, it is assumed that an imaging unit (not illustrated in FIG. 6) captures a vehicle 60 moving in the direction of an arrow 61, and that the analysis unit 113 detects the vehicle 60 from an image captured by the imaging unit and acquired by the acquisition unit 11, and that, in the case the vehicle 60 moves in the direction of the arrow 61 at the current movement speed, the communication quality of wireless communication between the wireless communication device 100 and a wireless communication device 120 is predicted to be reduced several seconds later, and the communication quality of wireless communication between the wireless communication device 100 and a wireless communication device 130 is predicted to be reduced several tens of seconds later. At the current time point, a connection for wireless communication for the wireless communication device 100 and the wireless communication device 120 is established, and the communication unit 17 is performing wireless communication with the wireless communication device 120. In this case, the switching unit 15 determines a wireless communication device 140 as the second wireless communication device which is the switching destination by using the method described in the first embodiment, cuts the connection for wireless communication with the wireless communication device 120, and establishes a connection for wireless communication with the wireless communication device 140, and the communication unit 17 performs wireless communication with the wireless communication device 140.

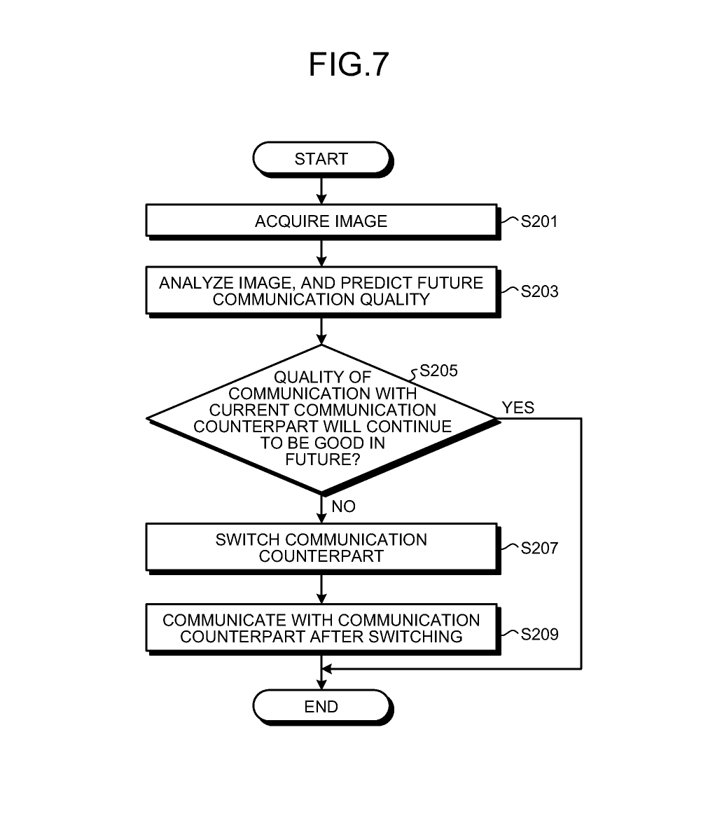

FIG. 7 is a flow chart showing an example of the flow of a switching method performed by the wireless communication device 100 of the second embodiment.

First, the process of step S201 is the same as the process of step S101 of the flow chart illustrated in FIG. 4.

Then, the analysis unit 113 analyzes an image acquired by the acquisition unit 11 and detects presence or absence of an object which is predicted to be an obstacle for wireless communication between the wireless communication device 100 and another wireless communication device to thereby predict the future communication quality of the wireless communication device 100 (step S203).

Next, the switching unit 15 checks, based on the analysis result of the analysis unit 113, whether the quality of communication with the other wireless communication device with which communication is currently being performed will continue to be good in the future or not (step S205).

The processes of the following steps S207 to S209 are the same as the processes of steps S107 to S109 of the flow chart illustrated in FIG. 4.

As described above, according to the second embodiment, when an object which is predicted to cause reduction in communication quality is detected from an image obtained by photographing the periphery of the wireless communication device, the communication counterpart is switched, and thus, the influence of reduction in communication quality may be prevented.

### Third Embodiment

In a third embodiment, a case of predicting reduction in communication quality using correlation information indicating a correlation between a change in image and a change in communication quality will be described. In the following, the difference to the second embodiment will be mainly described, and structural elements having the same functions as in the second embodiment will be denoted with the same names and reference signs as in the second embodiment, and their description will be omitted.

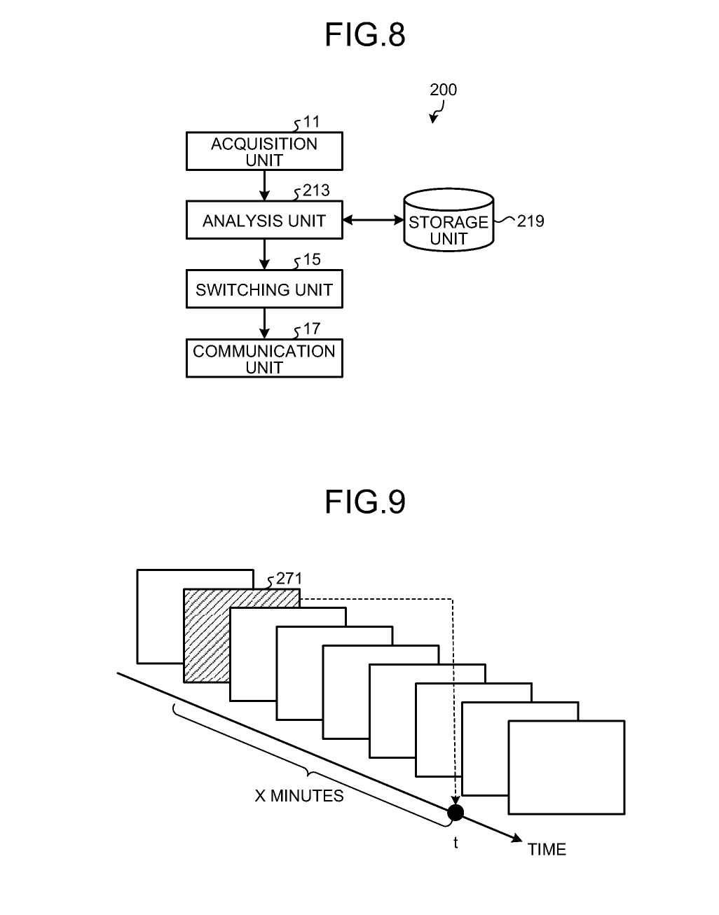

FIG. 8 is a configuration diagram illustrating an example of a wireless communication device 200 of the third embodiment. As illustrated in FIG. 8, the communication device 200 of the third embodiment is different from the second embodiment with respect to an analysis unit 213 and a storage unit 219.

The storage unit 219 may be implemented by a storage device capable of magnetic, optical or electrical storage, such as a HDD (Hard Disk Drive), a SSD (Solid State Drive), a memory card, an optical disk, a RAM (Random Access Memory), or a ROM (Read Only Memory), for example.

In addition to prediction of communication quality described in the second embodiment, the analysis unit 213 performs prediction of communication quality using correlation information indicating a correlation between a change in image and a change in communication quality. Since wireless communication devices are installed in various environments, it is difficult to perfectly predict the communication quality by using the method described in the second embodiment, and the prediction may turn out to be wrong.

If images obtained by photographing the periphery of the wireless communication device 200 are recorded in a chronological order, it is expected that a change in image that causes reduction in communication quality is also recorded. Basically, there is a correlation between reduction in communication quality and a change in image that causes the reduction in communication quality. Thus, if a pattern for each installation position of a wireless communication device, such as when a certain change occurs in an image, the communication quality of a certain wireless communication device is reduced by 10% five minutes later, may be learned, the accuracy of prediction of communication quality may be expected to increase.

Accordingly, the analysis unit 213 compares an image acquired by the acquisition unit 11 and a past image previously captured, and in the case there is a change equal to or greater than a threshold value therebetween, the analysis unit 213 associates the image and elapsed time from when the image is captured to when communication quality is changed, and stores the same as the correlation information in the storage unit 219.

Specifically, the analysis unit 213 compares images sequentially acquired by the acquisition unit 11 with an image acquired from an immediately preceding frame, and in the case a change in image equal to or greater than a threshold value is detected, the analysis unit 213 stores the image acquired by the acquisition unit 11 in the storage unit 219. For example, in the example illustrated in FIG. 9, an image 271 from which a change in image equal to or greater than a threshold value is detected is stored in the storage unit 219.

Furthermore the analysis unit 213 monitors the communication quality (for example, the intensity of radio wave) of the wireless communication device 200, measures the elapsed time from when a change in image equal to or greater than a threshold value is detected to when the communication quality of the wireless communication device 200 is reduced, and stores, in the storage unit 219, the elapsed time in association with the image from which the change in image equal to or greater than a threshold value has been detected. For example, in the example illustrated in FIG. 9, X minutes from detection of a change in image equal to or greater than a threshold value to time t at which reduction in the communication quality of the wireless communication device 200 has occurred is measured as the elapsed time, and X minutes and the predicted degree of reduction in communication quality are stored in the storage unit 219 in associated with the image 271.

Moreover, the reduction in communication quality may also be affected by time, such as a morning rush hour, and the time of occurrence of a change in image equal to or greater than a threshold value or reduction in communication quality may also be stored in the storage unit 219 in association.

The correlation information indicating a correlation (a relationship) between a change in image and a change in communication quality is thus stored in the storage unit 219.

Then, the analysis unit 213 analyzes the communication quality using an image acquired by the acquisition unit 11 and the correlation information stored in the storage unit 219. Specifically, the analysis unit 213 checks whether an image similar to the image acquired by the acquisition unit 11 is stored in the storage unit 219 or not, and if it is stored, the analysis unit 213 acquires the elapsed time stored in association with the image, and predicts that the communication quality will be reduced after the elapsed time thus acquired. Additionally, if the time is also stored in the storage unit 219, the time may also be used for matching.

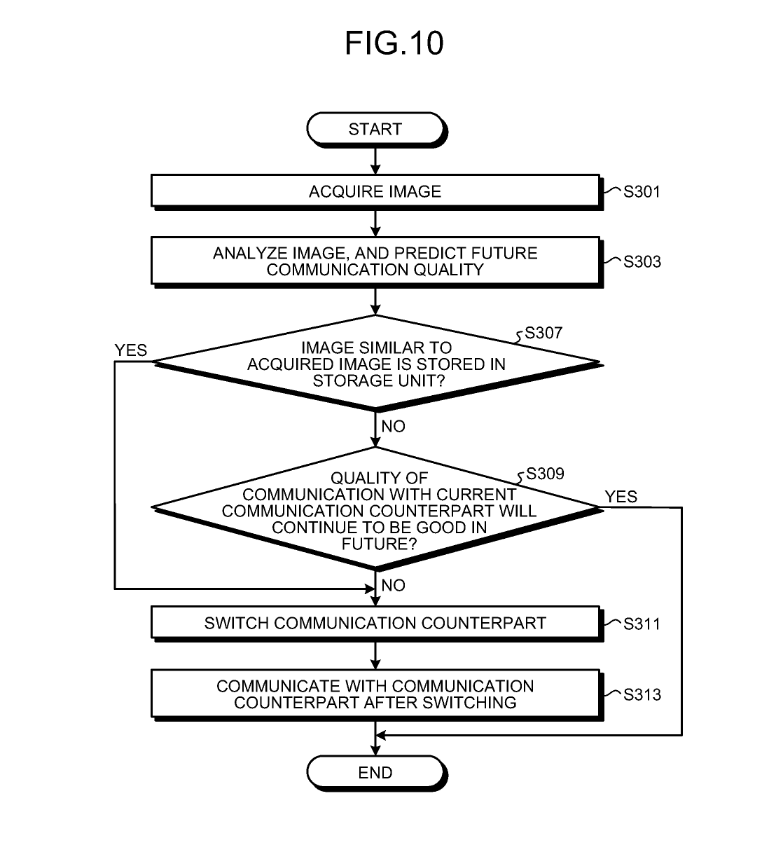

FIG. 10 is a flow chart showing an example of the flow of a switching method performed by the wireless communication device 200 of the third embodiment.

First, the processes of steps S301 to S303 are the same as the processes of steps S201 to S203 of the flow chart illustrated in FIG. 7.

Then, the analysis unit 213 checks whether an image similar to the image acquired by the acquisition unit 11 is stored in the storage unit 219 or not (step S307). Then, if a similar image is stored in the storage unit 219 (Yes in step S307), the analysis unit 213 acquires the elapsed time stored in association with the image, predicts that the communication quality will be reduced after the elapsed time acquired, and proceeds to step S311.

On the other hand, if a similar image is not stored in the storage unit 219 (No in step S307), the process flow proceeds to step S309.

The processes of the following steps S309 to S313 are the same as the processes of steps S205 to S209 of the flow chart illustrated in FIG. 7.

As described above, according to the third embodiment, since the relationship between a change in image and reduction in communication quality is learned, reduction in quality of communication around a wireless communication device may be accurately predicted, the communication counterpart is switched, and the influence of reduction in communication quality may be prevented.

Example Modification 1

In the second embodiment described above, the analysis unit 113 may predict not only the reduction in the communication quality, but also restoration of the communication quality, and the switching unit 15 may restore the communication counterpart at the timing at which the communication quality is predicted to be restored.

In this case, the analysis unit 113 may predict the time until an object which may be an obstacle exits the space in which an influence may be exerted on the communication quality of the wireless communication device 100, using the object detection or the optical flow. The switching unit 15 may thereby switch the communication counterpart at the timing at which the communication quality is predicted to be reduced, and restore the communication counterpart at the timing the communication quality is predicted to be restored.

According to the example modification 1, the timing of both the start and end of reduction in the communication quality can be predicted, and thus, there is no need to perform a test on whether the communication quality is restored, for example, and wasteful communication can be reduced and communication can be performed efficiently.

Example Modification 2

In each of the embodiments described above, an example is described where the switching unit 15 automatically switches the communication counterpart. Alternatively, an analysis result of the analysis unit may be output by an output unit to notify a user of the analysis result, and the communication counterpart may be switched based on an input (a user's instruction) through an operation unit.

The automatic switching between communication counterparts is not always accurate, and more flexible switching between communication counterparts is enabled in the above manner.

Example Modification 3

In the third embodiment described above, the analysis unit 213 stores the correlation information in the storage unit 219. Alternatively, the information may be transmitted to another wireless communication device, or may be managed by an external server, a cloud or the like. With this, the correlation information may be shared with other wireless communication devices. For example, in an office building or the like, there may be several rooms with a similar view or environment, and an image pattern and information about a change in communication environment obtained by a wireless communication device is possibly useful for another wireless communication device installed in a similar environment.

Example Modification 4

In each of the embodiments described above, a case where the wireless communication device performs wireless communication is described as an example, but application to a case where a communication device performs wired communication is also possible. For example, the communication efficiency may also be reduced in the case of wired communication due to the communication cable bending because of the weight of snow, birds or other obstacles.

Accordingly, the prediction method for the communication quality based on image recognition described in each of the embodiments described above may be applied, and the curvature or the like of the cable may be calculated, and in the case the cable is bent to a certain degree or more, or an obstacle such as a bird is detected, reduction in the communication quality may be predicted, the communication counterpart may be switched by the switching unit, and an efficient communication route may be secured.

Example Modification 5

Furthermore, in each of the embodiments described above, communication quality may be predicted based on an input from a sensor for detecting people, a door opening/closing sensor or the like, in addition to image recognition. With this, the cause of reduction in communication quality by the image recognition, such as presence or absence of passage of people, opening or closing of a door, or the like may be identified.

Hardware Configuration

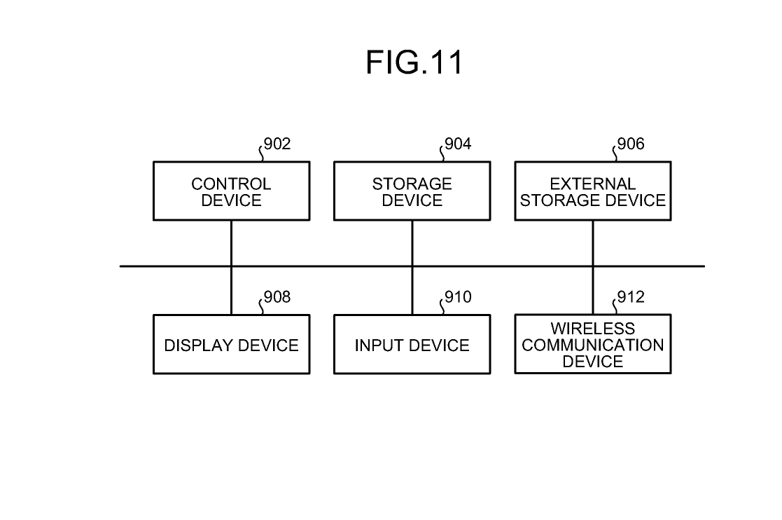

FIG. 11 is a diagram illustrating an example of a hardware configuration of the wireless communication device of each of the embodiments and example modifications described above. The wireless communication device of each of the embodiments and example modifications described above includes a control device 902 such as a CPU, a storage device 904 such as a ROM or RAM, an external storage device 906 such as a HDD, a display device 908 such as a display, an input device 910 such as a keyboard or a mouse, and a wireless communication device 912, and has a hardware configuration that uses a regular computer.

Programs to be executed by the wireless communication device of each of the embodiments and example modifications described above are provided, being stored in a computer-readable storage medium, such as a CD-ROM, a CD-R, a memory card, a DVD (Digital Versatile Disk), or a flexible disk (FD), in the form of an installable or executable file.

Furthermore, the programs to be executed by the wireless communication device of each of the embodiments and example modifications described above may be stored in a computer connected to a network such as the Internet, and may be provided by being downloaded via the network. Also, the programs to be executed by the wireless communication device of each of the embodiments and example modifications described above may be provided or distributed via a network such as the Internet. Moreover, the programs to be executed by the wireless communication device of each of the embodiments and example modifications described above may be provided, being embedded in a ROM or the like in advance.

The programs to be executed by the wireless communication device of each of the embodiments and example modifications described above are configured as a module for realizing each unit described above on a computer. As the actual hardware, each unit described above is realized on the computer by the CPU reading the programs from the HDD onto the RAM and executing the same.

The execution order of the steps of the flow charts of the embodiments described above may be changed without departing from their nature, and a plurality of steps may be performed at the same time, or the order may be changed for each mode of performance.

According to the communication device of at least one embodiment described above, the influence of reduction in communication quality may be suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
an analyzer configured to analyze an image taken at a periphery of the communication device;
a switching unit configured to switch a communication counterpart from a first communication device to a second communication device based on an analysis result of the image; and
a communication unit configured to communicate with the second communication device after switching.

2. The device according to claim 1, wherein the analyzer analyzes the image to detect presence or absence of an object predicted to be an obstacle for communication with the first communication device.

3. The device according to claim 1, further comprising:
a storage unit configured to store therein correlation information indicating a correlation between a change in image and a change in communication quality, wherein
the analyzer analyzes quality of communication with the first communication device using the image and the correlation information.

4. The device according to claim 3, wherein the analyzer compares the image with a past image previously photographed, and in a case there is a change equal to or greater than a threshold value between the image and the past image, the analyzer associates the image with elapsed time from when the image is photographed to when the quality of communication with the first communication device is changed, and stores, as the correlation information, the image and the elapsed time in the storage unit.

5. The device according to claim 4, wherein the analyzer further outputs the correlation information to an external device.

6. The device according to claim 1, wherein
the analyzer causes an output unit to output the analysis result, and
the switching unit switches the communication counterpart from the first communication device to the second communication device based on an input from an operation unit.

7. The device according to claim 1, wherein the communication unit performs wireless communication.

8. A communication method performed by a communication device, the method comprising:
analyzing, by an analysis unit, an image taken at a periphery of the communication device;
switching, by a switching unit, a communication counterpart from a first communication device to a second communication device based on an analysis result of the image; and
communicating, by a communication unit, with the second communication device after switching.

9. A computer program product comprising a computer-readable medium containing a computer program that causes a computer to execute:
analyzing an image taken at a periphery of the computer;
switching a communication counterpart from a first communication device to a second communication device based on an analysis result of the image; and
communicating with the second communication device after switching.
